(19) United States
(12) Patent Application Publication
(10) Pub. No.: US 2018/0091265 A1
(43) Pub. Date: Mar. 29, 2018

(54) System and Method for D2D Communication

(71) Applicant: Futurewei Technologies, Inc., Plano, TX (US)

(72) Inventors: Bin Liu, San Diego, CA (US); Yongbo Zeng, Beijing (CN); Richard Stirling-Gallacher, San Diego, CA (US); Aimin Justin Sang, San Diego, CA (US)

(21) Appl. No.: 15/279,147

(22) Filed: Sep. 28, 2016

(51) Int. Cl. H04L 1/18; H04L 5/00; H04L 1/08; H04W 72/12

(52) U.S. Cl. CPC H04L 1/1887; H04L 5/0055; H04W 76/023; H04W 72/1226; H04L 1/08

(57) ABSTRACT

A system and method for device-to-device (D2D) communication includes a method. The method includes acquiring, by a destination user equipment (UE), a transmission scheduling assignment. The transmission scheduling assignment indicates transmission resources and feedback resources. The method further includes receiving, by the destination UE, a transmission using the transmission resources indicated by the transmission scheduling assignment. The method further includes determining, by the destination UE, a receive quality of the transmission. The method further includes indicating, by the destination UE, receipt of the transmission according to the receive quality of the transmission. The indicating is performed using the feedback resources indicated by the transmission scheduling assignment.

### TECHNICAL FIELD

The present invention relates generally to wireless network communications, and, in particular embodiments, to a system and method for device-to-device (D2D) communication.

### BACKGROUND

D2D communication may be used to offer new services, improve system throughput, and offer a better user experience in mobile devices. In future wireless networks, there may be a large quantity of user equipments (UEs) that serve different purposes. D2D communication may be an important aspect of future wireless networks. Potential use cases for D2D also include proximity-based services (ProSe). As wireless technologies have continued to develop, new challenges in D2D communication are being discovered.

### SUMMARY

In accordance with a preferred embodiment of the present invention, a method includes: acquiring, by a destination user equipment (UE), a transmission scheduling assignment, the transmission scheduling assignment indicating transmission resources and feedback resources; receiving, by the destination UE, a transmission using the transmission resources indicated by the transmission scheduling assignment; determining, by the destination UE, a receive quality of the transmission; and indicating, by the destination UE, receipt of the transmission according to the receive quality of the transmission, the indicating using the feedback resources indicated by the transmission scheduling assignment.

In accordance with a preferred embodiment of the present invention, a method includes: acquiring, by a helper user equipment (UE), a transmission scheduling assignment, the transmission scheduling assignment indicating transmission resources and feedback resources; receiving, by the helper UE, a transmission using the transmission resources indicated by the transmission scheduling assignment; determining, by the helper UE, a receive quality of the transmission; and monitoring, by the helper UE, for a negative acknowledgement (NACK) with the feedback resources in response to the receive quality of the transmission being greater than a threshold.

In accordance with a preferred embodiment of the present invention, a method includes: transmitting, by a sending user equipment (UE), a transmission scheduling assignment, the transmission scheduling assignment indicating transmission resources and feedback resources; performing, by the sending UE, a transmission using the transmission resources indicated by the transmission scheduling assignment; receiving, by the sending UE, a negative acknowledgement (NACK) using the feedback resources; and performing, by the sending UE, a retransmission in response to receiving the NACK, the retransmission and the transmission including the same payload information.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a network;

FIG. 2 is a diagram of UEs in a network;

FIG. 3 is a sequence diagram showing a D2D communication method;

FIG. 4 is a timing diagram showing resource usage when performing unicast transmissions;

FIG. 5 is a diagram of UEs in a network;

FIG. 6 is a sequence diagram showing a D2D communication method;

FIG. 7 is a timing diagram showing resource usage when performing broadcast transmissions;

FIG. 8 is a block diagram of a processing system; and

FIG. 9 is a block diagram of a transceiver.

### DETAILED DESCRIPTION OF ILLUSTRATIVE EMBODIMENTS

Hybrid automatic repeat request (hybrid ARQ or HARQ) is a mechanism that may be used to improve D2D communication. Various embodiments use HARQ mechanisms over sidelink communication channels to improve the reliability of D2D communication links. In particular, UEs in a D2D communication link self-schedule HARQs between one another. A source UE (SUE) (e.g., a transmitting UE) indicates a resource in a scheduling assignment (SA) (e.g., resources or a resource block), for both transmission of data packets and transmission of an ACK/NACK, to a destination UE (DUE) (e.g., a receiving UE). Then the SUE sends the data packets to the DUE in the scheduled resource. After the transmission, the DUE sends an acknowledgement (ACK) or a negative-acknowledgement (NACK) in the resource scheduled by the SA to the SUE, which indicate a successful or a failed transmission, respectively. The SUE retransmits the data packets to the DUE in response to the NACK. In unicast D2D communication, the DUE may determine the retransmission resource and indicate it in a corresponding SA to the SUE together with the NACK. Alternatively, the retransmission may be scheduled by the SUE, similar to the original transmission. In broadcast D2D communication, the SUE determines the resource allocation for retransmission by indicating it in a new SA to the DUE before performing the retransmission. Optionally, in broadcast D2D communication, a helper UE (HUE) in the D2D communication link aids in retransmitting the data packets during the retransmission. The HUE aids with retransmission according to, e.g., the quality of the received NACK.

Various embodiments may achieve advantages. Self-scheduling HARQ between UEs in a D2D communication link may reduce the HARQ round-trip time (RTT) delay. Further, self-scheduling HARQ may avoid the need for network assistance in scheduling HARQ between UEs, reducing signaling overhead in the network links and simplifying HARQ mechanisms. Reducing the RTT delay and simplifying HARQ may improve the reliability and performance of D2D communication links in the network.

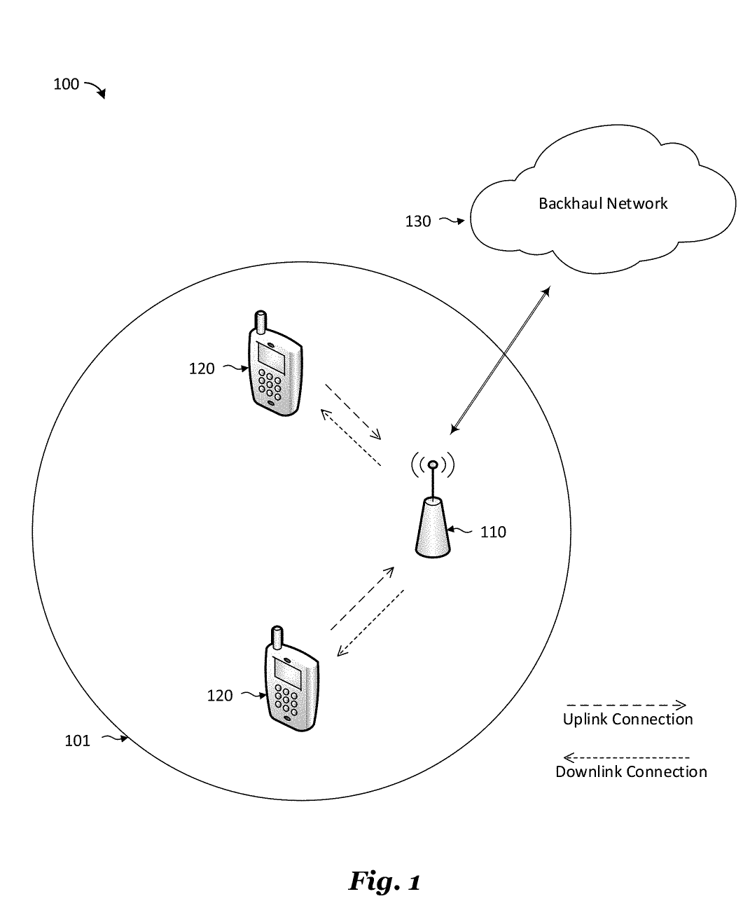

FIG. 1 is a diagram of a network 100 for communicating data. The network 100 comprises a base station no having a coverage area 101, a plurality of mobile devices 120, and a backhaul network 130. As shown, the base station no establishes uplink (dashed line) and/or downlink (dotted line) connections with the mobile devices 120, which serve to carry data from the mobile devices 120 to the base station no and vice-versa. Data carried over the uplink/downlink connections may include data communicated between the mobile devices 120, as well as data communicated to/from a remote-end (not shown) by way of the backhaul network 130. As used herein, the term “base station” refers to any component (or collection of components) configured to provide wireless access to a network, such as an enhanced base station (eNB), a macro-cell, a femtocell, a Wi-Fi access point (AP), or other wirelessly enabled devices. Base stations may provide wireless access in accordance with one or more wireless communication protocols, e.g., long term evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with a base station, such as a UE, a mobile station (STA), and other wirelessly enabled devices. In some embodiments, the network 100 may comprise various other wireless devices, such as relays, low power nodes, etc.

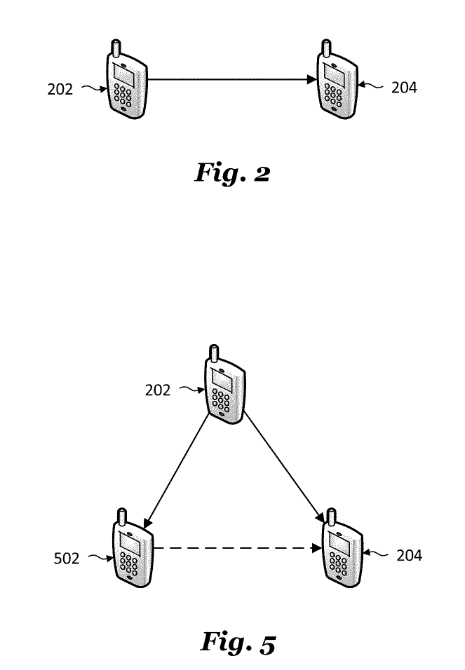

FIG. 2 is a diagram of UEs in the network 100. The UEs communicate over a D2D communication link, and include a SUE 202 and a DUE 204. In FIG. 2, the SUE 202 and the DUE 204 communicate in a unicast or point-to-point type scenario. The SUE 202 transmits data to the DUE 204, the DUE 204 indicates successful or failed reception of the transmission, and the DUE 204 requests retransmission with HARQ upon detecting a transmission failure.

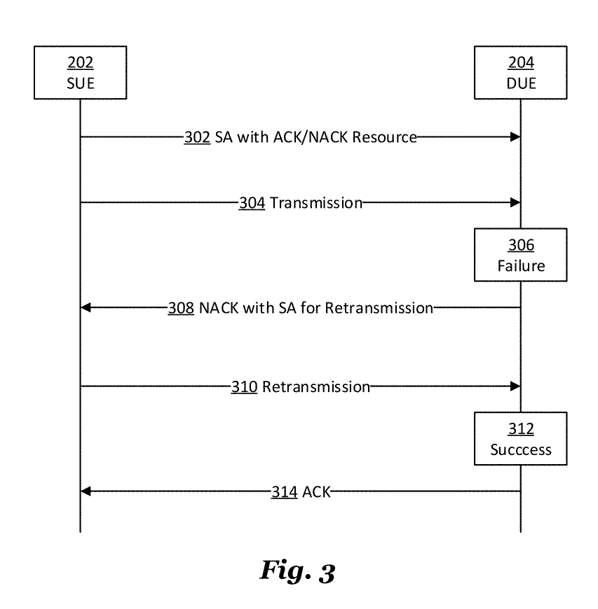

FIG. 3 is a sequence diagram showing a D2D communication method used to perform unicast transmissions between UEs. Defined resources (e.g., time or frequency resources) in the network 100 are scheduled for use in the unicast transmissions between the SUE 202 and the DUE 204.

The SUE 202 indicates a transmission SA to the DUE 204 (step 302). The transmission SA indicates resources that will be used to perform a transmission (e.g., transmission resources). The transmission SA also indicates resources to be used for an ACK/NACK by the DUE 204 in a feedback link (e.g., feedback resources). For example, the transmission SA may indicate a resource for forward data transmission, and a resource for ACK/NACK feedback. The SUE 202 may indicate the transmission SA by sending a special separate message to the DUE 204, or may indicate it by modifying a message called for by a communications standard. For example, in LTE, the transmission SA may be indicated on the Physical Sidelink Shared Channel (PSSCH) or the Physical Sidelink Discovery Channel (PSDCH). The transmission SA may be indicated using a data structure similar to the structure indicated below in Table 1. The DUE 204 acquires the data structure from the SUE 202.

TABLE 1
Changes in LTE D2D SA for HARQ.

| Field | Length | Comment |
|---|---|---|
| TA | 6 bits | D2D reception timing adjustment for SA. |
| MCS | 5 bits | Modulation and coding scheme. |
| T-RPT | 7 bits | Indicates ACK/NACK allocation. |
| ID | 8 bits | Indicates ID of D2D UE. |
| Frequency Resource | 5-13 bits | |
| Indication | | |
| Frequency Hopping | 1 bit | |
| Indication | | |
| Frequency Resource | 5-13 bits | Indicates retransmission SA. |
| Indication for | | Length depends on |
| ACK/NACK | | system bandwidth. |
| HARQ Control | Variable | Other information such as HARQ ID, |
| Information | | new data indicators, etc. |

The SUE 202 performs a transmission to the DUE 204 according to the transmission SA (step 304). For example, the D2D communication link may be configured by the SUE 202 using parameters in the transmission SA, and then used to perform the transmission. In LTE, the transmission may be performed over a sidelink channel such as the PSSCH. The transmission is used to send information or data directly to the DUE 204.

The DUE 204 may detect a failure when receiving the transmission (step 306). The failure may be caused by a variety of sources. For example, in wireless D2D communication, the failure may be caused by errors in the air interface between the SUE 202 and the DUE 204. The DUE 204 may detect the failure using a variety of error checking or coding techniques. For example, in LTE, the DUE 204 may detect the error by determining a cyclic redundancy check (CRC) code in the transmission does not match an expected value.

After receiving the transmission, the DUE 204 transmits feedback that includes an ACK/NACK to the SUE 202 (step 308). The ACK/NACK is transmitted on the resource for ACK/NACK feedback indicated by the transmission SA. If the transmission succeeded, an ACK is transmitted to the SUE 202. If the transmission failed, a NACK is transmitted to the SUE 202. The DUE 204 may also indicate a retransmission SA with the NACK (e.g., retransmission resources). Indicating the retransmission SA when sending the NACK may reduce the quantity of signaling in the network 100, reducing the HARQ RTT between the SUE 202 and the DUE 204.

In unicast scenarios, the DUE 204 may send a retransmission SA. In this scenario, the size of the resource scheduled for retransmission may be different from the size of the resource scheduled for the original transmission. In some embodiments, the DUE 204 may adapt the retransmission resource. For example, the DUE 204 may select the retransmission resource according to the quality of the original transmission. For example, if the original transmission had a relatively high signal-to-interference-plus-noise ratio (SINR), less information may be needed in retransmission, and so fewer resources may be scheduled by DUE 204 to use for retransmission.

If the feedback link fails, then the SUE 202 may not receive the ACK/NACK. If an ACK/NACK is not received, the SUE 202 may repeat the transmission (step 304) after a predefined amount of time elapses.

The SUE 202 performs retransmission to the DUE 204 according to the retransmission SA (step 310). The retransmission may include the same payload information (e.g., when chase combining is used), or may include different payload information with different redundant version (e.g., when incremental redundancy is used) that was sent in the original transmission. However, since the retransmission is performed according to the retransmission SA received from the DUE 204, the retransmission may be performed using different resources in the network 100.

The DUE 204 detects a successful transmission (step 312). The success may be detected using the same mechanisms used to detect the failure. Although the method in FIG. 3 shows one transmission, one failure, and one retransmission, it should be appreciated that any number of transmissions and retires could occur in a network. For example, there may be no failures, or there may be a plurality of failures and retransmissions.

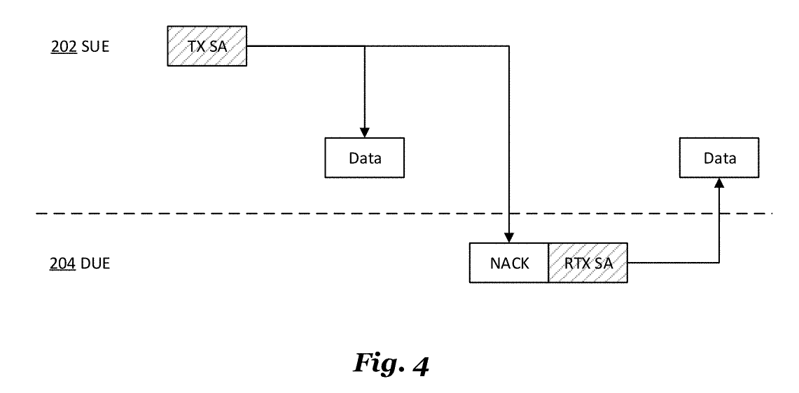

FIG. 4 is a timing diagram showing resource usage when performing unicast transmissions between the SUE 202 and the DUE 204. In FIG. 4, shaded blocks indicate resources in an SA resource pool for the network, and blank blocks indicate resources in a data resource pool for the network. The transmission SA (TX SA) is used by the SUE 202 to schedule resources for the data transmission as well as the ACK/NACK transmission. The DUE 204 also indicates the retransmission SA (RTX SA) when the NACK is transmitted. The retransmission SA indicates resources used by the SUE 202 to retransmit the data.

FIG. 5 is a diagram of UEs in the network 100. The UEs communicate over a D2D communication link, and include a SUE 202, a DUE 204, and a HUE 502. In FIG. 5, the UEs communicate in a broadcast or one-to-many type scenario. The SUE 202 transmits data to the DUE 204 and the HUE 502, and the DUE 204 requests retransmissions upon detecting a transmission failure. The SUE 202 and the HUE 502 jointly perform the retransmission to the DUE 204.

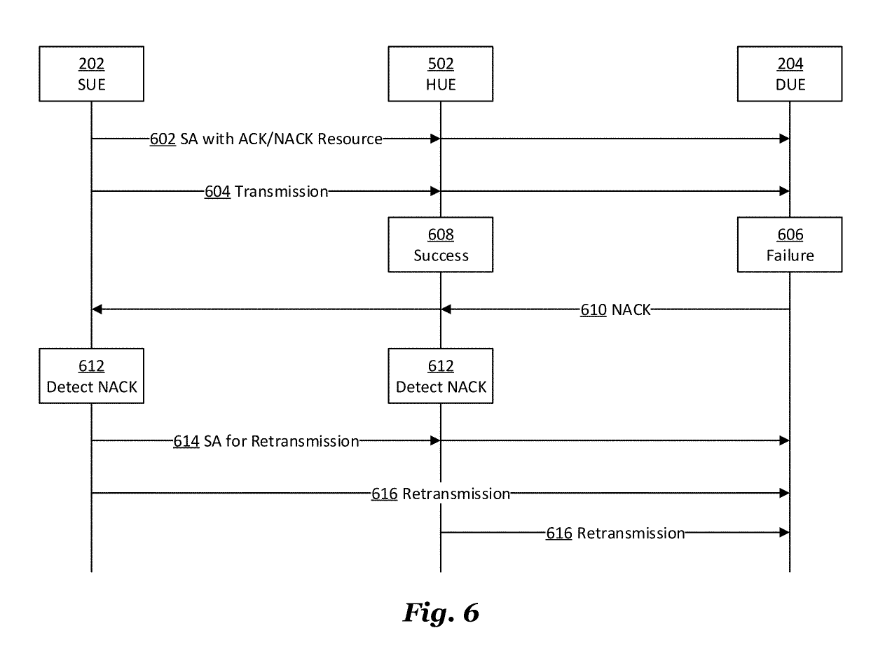

FIG. 6 is a sequence diagram showing a D2D communication method used to perform broadcast transmissions between UEs. Defined resources (e.g., time or frequency resources) in the network 100 are scheduled for used in the broadcast transmissions between the SUE 202, the DUE 204, and the HUE 502. The method shown in FIG. 6 is similar to the method shown in FIG. 3, except the HUE 502 assists the SUE 202 when performing retransmissions.

The SUE 202 indicates the transmission SA to the DUE 204 and the HUE 502 (step 602). Similar to step 302 above, the transmission SA indicates resources that will be used by the SUE 202 to perform a transmission and receive an ACK/NACK.

The SUE 202 performs a transmission to the DUE 204 and the HUE 502 according to the transmission SA (step 604). The SUE 202 performs the transmission as a broadcast, such that the DUE 204 and the HUE 502 receive it simultaneously.

The DUE 204 may detect a failure when receiving the transmission (step 606), and the HUE 502 may detect a success (step 608). The success and failure detection may be performed by each UE in a similar manner as that discussed above in step 306.

The DUE 204 sends a NACK to the SUE 202 in response to detecting the failure (step 610). Similar to the unicast scenario above, the NACK is sent in the resource scheduled by the transmission SA. In broadcast scenarios, the HUE 502 may not send an ACK in response to detecting a successful transmission.

The SUE 202 and the HUE 502 both receive the NACK from the DUE 204 (step 612). The HUE 502 may listen for and receive the NACK in response to successfully receiving a transmission in step 608. The HUE 502 listens for the NACK in the resource indicated by the transmission SA sent from the SUE 202 before the transmission. In some embodiments, the HUE 502 may always participate in retransmission after receiving the NACK. In some embodiments, the HUE 502 participates in retransmission if the quality of the received NACK is above a threshold.

The SUE 202 indicates the retransmission SA to the DUE 204 and the HUE 502 (step 614). In broadcast scenarios, the SUE 202 determines the retransmission SA. The transmission SA and the retransmission SA in broadcast scenarios may be similar to the format shown above in Table 1 for unicast scenarios.

A retransmission to the DUE 204 is performed according to the retransmission SA (step 616). The SUE 202 and the HUE 502 may both participate in the retransmission. The HUE 502 aids in the retransmission in response to receiving the indication of the retransmission SA from the SUE 202. The HUE 502 may use redundant version (RV) HARQ for the retransmission. RV can be indicated in retransmission SA or preconfigured on the UEs.

If the feedback link from the DUE 204 to the SUE 202 fails, then the HUE 502 may receive the NACK but may not receive an indication of the retransmission SA from the SUE 202. This may occur if, for example, the HUE 502 receives the NACK but the SUE 202 does not. In some embodiments, the HUE 502 performs the retransmission with a normal sidelink transmission to the DUE 204 if it does not receive the retransmission SA within a predefined amount of time. In some embodiments, the HUE 502 simply ignores the NACK if it does not receive the retransmission SA.

Although the method shown in FIG. 6 shows one transmission, one failure, and one retransmission, it should be appreciated that any number of transmissions and retires could occur, and may occur with any quantity of destination or helper UEs. For example, there may be no failures, or there may be a plurality of failures and retransmissions. Likewise, there may be more than one HUE 502, and/or more than one DUE 204 that requests retransmission.

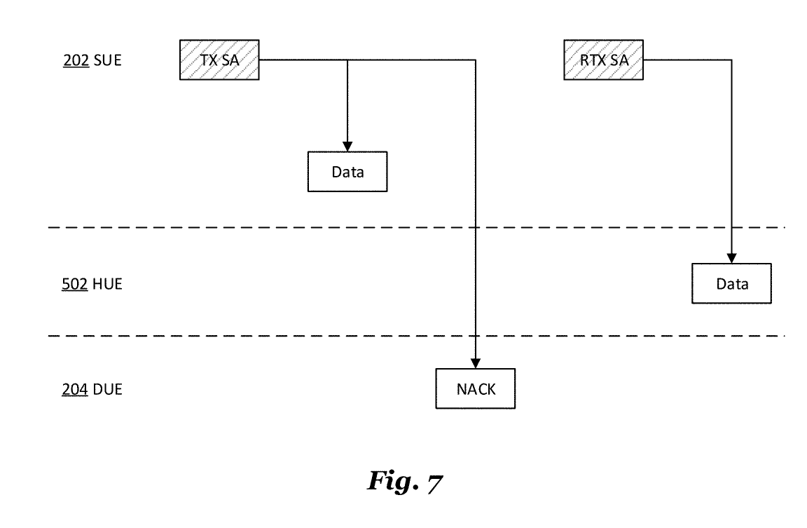

FIG. 7 is a timing diagram showing resource usage when performing broadcast transmissions between the SUE 202, the DUE 204, and the HUE 502. In FIG. 7, shaded blocks indicate resources in an SA resource pool for the network, and blank blocks indicate resources in a data resource pool for the network. The transmission SA (TX SA) is used by the SUE 202 to transmit the resource scheduling assignment, which schedules the resources for data transmission and for the DUE 204 to transmit the NACK. The SUE 202 also indicates the retransmission SA (RTX SA) to the DUE 204 and the HUE 502. The retransmission SA indicates resources used by the SUE 202 and the HUE 502 to retransmit the data.

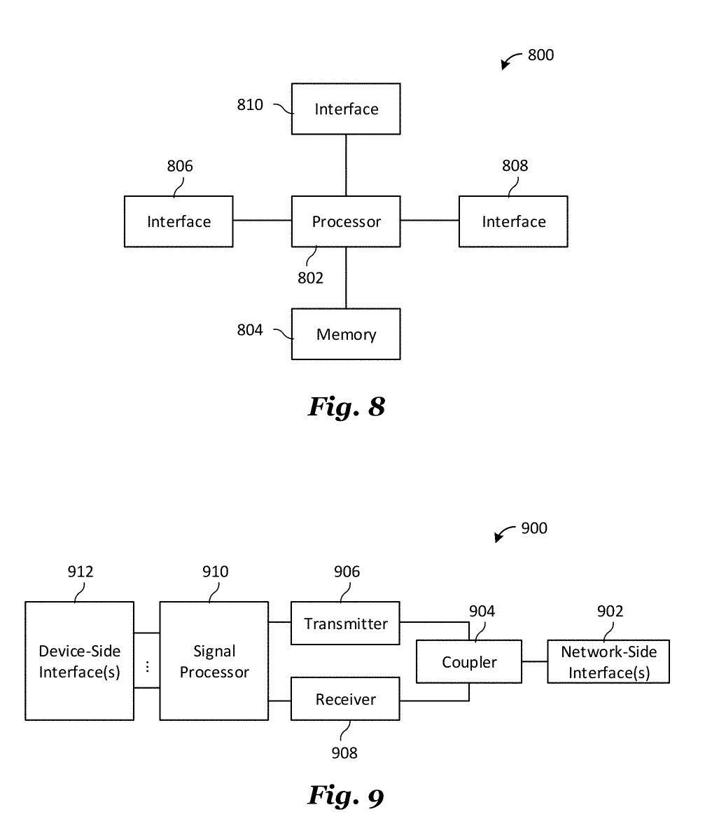

FIG. 8 is a block diagram of a processing system 800 for performing methods described herein, which may be installed in a host device. As shown, the processing system 800 includes a processor 802, a memory 804, and interfaces 806-810, which may (or may not) be arranged as shown in FIG. 8. The processor 802 may be any component or collection of components adapted to perform computations and/or other processing related tasks, and the memory 804 may be any component or collection of components adapted to store programming and/or instructions for execution by the processor 802. In an embodiment, the memory 804 includes a non-transitory computer readable medium. The interfaces 806, 808, 810 may be any component or collection of components that allow the processing system 800 to communicate with other devices/components and/or a user. For example, one or more of the interfaces 806, 808, 810 may be adapted to communicate data, control, or management messages from the processor 802 to applications installed on the host device and/or a remote device. As another example, one or more of the interfaces 806, 808, 810 may be adapted to allow a user or user device (e.g., personal computer (PC), etc.) to interact/communicate with the processing system 800. The processing system 800 may include additional components not depicted in FIG. 8, such as long term storage (e.g., non-volatile memory, etc.).

In some embodiments, the processing system 800 is included in a network device that is accessing, or part otherwise of, a telecommunications network. In one example, the processing system 800 is in a network-side device in a wireless or wireline telecommunications network, such as a base station, a relay station, a scheduler, a controller, a gateway, a router, an applications server, or any other device in the telecommunications network. In other embodiments, the processing system 800 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 806, 808, 810 connects the processing system 800 to a transceiver adapted to transmit and receive signaling over the telecommunications network. FIG. 9 is a block diagram of a transceiver 900 adapted to transmit and receive signaling over a telecommunications network. The transceiver 900 may be installed in a host device. As shown, the transceiver 900 comprises a network-side interface 902, a coupler 904, a transmitter 906, a receiver 908, a signal processor 910, and a device-side interface 912. The network-side interface 902 may include any component or collection of components adapted to transmit or receive signaling over a wireless or wireline telecommunications network. The coupler 904 may include any component or collection of components adapted to facilitate bi-directional communication over the network-side interface 902. The transmitter 906 may include any component or collection of components (e.g., up-converter, power amplifier, etc.) adapted to convert a baseband signal into a modulated carrier signal suitable for transmission over the network-side interface 902. The receiver 908 may include any component or collection of components (e.g., down-converter, low noise amplifier, etc.) adapted to convert a carrier signal received over the network-side interface 902 into a baseband signal. The signal processor 910 may include any component or collection of components adapted to convert a baseband signal into a data signal suitable for communication over the device-side interface(s) 912, or vice-versa. The device-side interface(s) 912 may include any component or collection of components adapted to communicate data-signals between the signal processor 910 and components within the host device (e.g., the processing system 800, local area network (LAN) ports, etc.).

The transceiver 900 may transmit and receive signaling over any type of communications medium. In some embodiments, the transceiver 900 transmits and receives signaling over a wireless medium. For example, the transceiver 900 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 902 comprises one or more antenna/radiating elements. For example, the network-side interface 902 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 900 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by an acquiring unit/module, a receiving unit/module, a determining unit/module, an indicating unit/module, a sending unit/module, an accessing unit/module, a monitoring unit/module, a performing unit/module, and/or a transmitting unit/module. The respective units/modules may be hardware, software, or a combination thereof. For instance, one or more of the units/modules may be an integrated circuit, such as field programmable gate arrays (FPGAs) or application-specific integrated circuits (ASICs).

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method comprising:
acquiring, by a destination user equipment (UE), a transmission scheduling assignment, the transmission scheduling assignment indicating transmission resources and feedback resources;
receiving, by the destination UE, a transmission using the transmission resources indicated by the transmission scheduling assignment;
determining, by the destination UE, a receive quality of the transmission; and
indicating, by the destination UE, receipt of the transmission according to the receive quality of the transmission, the indicating using the feedback resources indicated by the transmission scheduling assignment.

2. The method of claim 1, wherein indicating receipt of the transmission comprises:
sending, by the destination UE, an acknowledgement (ACK) using the feedback resources in response to the receive quality of the transmission being greater than a threshold.

3. The method of claim 1, wherein indicating receipt of the transmission comprises:
sending, by the destination UE, a negative acknowledgement (NACK) using the feedback resources in response to the receive quality of the transmission being less than a threshold.

4. The method of claim 3, further comprising:
accessing, by the destination UE, a retransmission scheduling assignment, the retransmission scheduling assignment indicating retransmission resources; and
receiving, by the destination UE, a retransmission using the retransmission resources indicated by the retransmission scheduling assignment, the retransmission and the transmission including the same payload information.

5. The method of claim 4, wherein accessing the retransmission scheduling assignment comprises:
determining, by the destination UE, the retransmission scheduling assignment; and
sending, by the destination UE, the retransmission scheduling assignment using the feedback resources.

6. The method of claim 4, wherein accessing the retransmission scheduling assignment comprises:
receiving, by the destination UE, the retransmission scheduling assignment.

7. The method of claim 4, wherein the retransmission is received from a device that originally performed the transmission.

8. The method of claim 4, wherein the retransmission is received from a device that did not originally perform the transmission.

9. The method of claim 4, wherein the transmission resources and the retransmission resources are different network resources.

10. The method of claim 4, wherein the transmission resources and the retransmission resources are the same network resources.

11. A method comprising:
acquiring, by a helper user equipment (UE), a transmission scheduling assignment, the transmission scheduling assignment indicating transmission resources and feedback resources;
receiving, by the helper UE, a transmission using the transmission resources indicated by the transmission scheduling assignment;
determining, by the helper UE, a receive quality of the transmission; and
monitoring, by the helper UE, for a negative acknowledgement (NACK) with the feedback resources in response to the receive quality of the transmission being greater than a threshold.

12. The method of claim 11, further comprising:
receiving the NACK; and
performing, by the helper UE, a retransmission according to receive quality of the NACK, the retransmission and the transmission including the same payload information.

13. The method of claim 12, further comprising:
receiving, by the helper UE, the NACK using the feedback resources; and
acquiring, by the helper UE, a retransmission scheduling assignment after receiving the NACK, the retransmission scheduling assignment indicating retransmission resources, the retransmission performed using the retransmission resources.

14. The method of claim 13, wherein the NACK is received from a device that did not originally perform the transmission.

15. The method of claim 13, wherein the transmission resources and the retransmission resources are different network resources.

16. The method of claim 13, wherein the transmission resources and the retransmission resources are the same network resources.

17. A method comprising:
transmitting, by a sending user equipment (UE), a transmission scheduling assignment, the transmission scheduling assignment indicating transmission resources and feedback resources;
performing, by the sending UE, a transmission using the transmission resources indicated by the transmission scheduling assignment;
receiving, by the sending UE, a negative acknowledgement (NACK) using the feedback resources; and
performing, by the sending UE, a retransmission in response to receiving the NACK, the retransmission and the transmission including the same payload information.

18. The method of claim 17, further comprising:
acquiring, by the sending UE, a retransmission scheduling assignment after receiving the NACK, the retransmission scheduling assignment indicating retransmission resources, the retransmission performed using the retransmission resources.

19. The method of claim 18, wherein acquiring the retransmission scheduling assignment comprises:
receiving, by the sending UE, the retransmission scheduling assignment using the feedback resources with the NACK.

20. The method of claim 18, wherein acquiring the retransmission scheduling assignment comprises:
determining, by the sending UE, the retransmission scheduling assignment.
